(19) United States
(12) Patent Application Publication
(10) Pub. No.: US 2013/0292910 A1
(43) Pub. Date: Nov. 7, 2013

(54) Gland Packing Placed Between Two Opposite Elements Around a Shaft

(71) Applicants: Grégory Tocheport, Saint-Etienne (FR); Jean-Jacques Darque, Launaguet (FR); David Lombard, Saint Sauveur En Rue (FR); Stéphane Guignard, Montbrison (FR); Laurent Guimet, Unieux (FR); Bruno Rouchouze, Saint Jean De Bonnefonds (FR); Jean-François Juliaa, Montelimar (FR)

(72) Inventors: Grégory Tocheport, Saint-Etienne (FR); Jean-Jacques Darque, Launaguet (FR); David Lombard, Saint Sauveur En Rue (FR); Stéphane Guignard, Montbrison (FR); Laurent Guimet, Unieux (FR); Bruno Rouchouze, Saint Jean De Bonnefonds (FR); Jean-François Juliaa, Montelimar (FR)

(73) Assignee: TECHNETICS GROUP FRANCE SAS, SAINT ETIENNE (FR)

(21) Appl. No.: 13/880,990

(22) PCT Filed: Oct. 25, 2011
(86) PCT No.: PCT/EP2011/068597

§ 371 Date: Jun. 21, 2013

(30) Foreign Application Priority Data
Oct. 27, 2010 (FR) 10 58824

(51) Int. Cl. F16J 15/34

(52) U.S. Cl. CPC F16J 15/34
USPC 277/521

(57) ABSTRACT

Compression between two blocks (5, 6) forming a dynamic seal (13) between a rotor (2) and a stator (1) is applied by an inflatable seal (7) located in a groove. When blocks (5 and 6) must be cuttable, in other words divided into two parts to be assembled around the shaft (2), the originally linear seal (7) is wound in the groove and its ends are in contact with each other. It applies a uniform compression around the circumference and its placement does not require major disassembly of the equipment.

The invention relates to gland packing arranged between two opposite elements around a shaft.

Such packing comprises two blocks connected to opposite elements and in mutual contact through plane slip faces, and a compression means arranged between one of the blocks and the corresponding element to apply and maintain a contact pressure between the plane faces that provides the seal. The opposite elements usually belong to a rotor and to a stator and the plane faces that slip relative to each other then form a dynamic seal. Other sealing means that are not part of the invention are arranged between the elements and the blocks to complete the seal statically.

It is preferred to make continuous blocks, therefore extending around complete rings and then slide them in sequence around the shaft; but this is sometimes impossible if both ends of the shaft are occupied by voluminous parts or is at least difficult if these parts have to be disassembled so that the sealing blocks can be slid into place.

This is why blocks have been designed, each of which is divided into portions extending around the shaft over complementary sectors of the circumference, that are brought together and assembled by closing them on the shaft. Such elements are illustrated for example in document U.S. Pat. No. 5,961,122 and are called “cuttable”. The compression means that is then normally applied is a network of springs parallel to the shaft and distributed around a circumference. Its disadvantage is that the pressure necessary for the seal may sometimes become irregular due to unequal forces applied by the springs resulting from manufacturing tolerances and therefore inequalities of resulting forces applied to each “cuttable” element that do not transmit axial forces to each other.

The invention relates to gland packing of the type mentioned above in which the compression means is improved so that it applies a uniform force around the entire circumference on which it bears even if it is shared between cuttable blocks. One aspect that has to be mentioned is that the compression means may also be mounted around the shaft by an essentially radial movement, such as cuttable blocks with which it shares the advantage that it does not need to be slid along the shaft.

In one general form, the invention relates to gland packing arranged between two opposite elements and around a shaft extending between the two elements, packing comprising two blocks connected to elements and in mutual contact through plane slip faces, each of the blocks being divided into portions extending over complementary sectors of the circumference around the shaft, and a compression means arranged between one of the elements and one of the blocks and maintaining the slip faces in contact; the compression means is an inflatable seal located in a groove of said element and comprising a flexible envelope comprising two adjacent closed ends in the groove, and an inflation orifice. The innovation of the invention lies in the combination of sectors divided into blocks and a single seal because it is discontinuous; equality of the calibration pressure is respected, as is the possibility of disassembling packing alone, by radial movements, away from the shaft, although the seal extends around the entire circumference. Note that prior art describes gland packing with inflatable seals for calibration, but they are continuous (without any material ends) while the blocks are also continuous: for example FR-A-2 239 159, EP-A-0 065 646 and DE-A-32 12 939.

The seal is deflated and therefore soft during assembly, which means that it can easily be put into place in the groove by winding it around the shaft and assembling its ends, and it is then inflated and therefore transmits the compression necessary for correct operation of packing. Since the pressure inside the envelope is necessarily uniform, an equal force is applied to the portions of blocks. The only possible inequality is at the junction of the ends of the envelope, but it is almost imperceptible.

According to preferred embodiments, the envelope is advantageously tubular and the ends have plane faces and are connected to end contours of the envelope. The ends may consist solely of these plane faces or they may consist of end pieces provided with tubular portions that extend the tube of the envelope. The envelope section is advantageously prismatic when it is inflated, the ends having an identical prismatic and preferably essentially rectangular shape. The force obtained is then more uniform, the seal bearing perfectly on the three faces inside the groove and on the block through a fourth face. However, the contact is leak tight if the envelope has one face bearing on the block on which parallel teeth are formed extending from one end to the other.

The orifice advantageously comprises a filling valve that maintains the seal at the required pressure after filling. This valve can be placed in a conduit of this element opening to the outside, or in a conduit opening into a fluid volume contained by packing. In this final design, the fluid itself is retained by packing that inflates the seal due to its pressure. In a more advantageous design, the fluid volume is divided by a flexible membrane into a main volume opening onto slip faces and an ancillary volume opening into the conduit: this is preferred when the fluid is polluting, corrosive or contains impurities, to prevent the inside of the seal getting dirty or damaged in any other way; an inoffensive fluid is poured into the ancillary volume and fills the seal, at a pressure that is still transmitted to it by the main fluid to be contained.

According to another improved embodiment, the seal may contain a flexible stiffening element with non deformable sections, that limits its compression.

The various aspects of the invention will now be described with reference to the following figures:

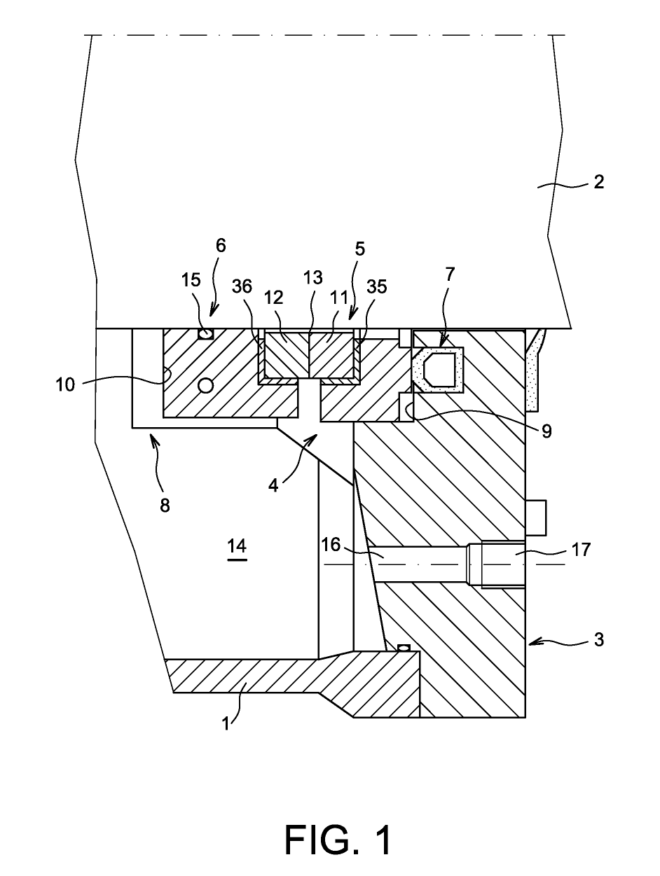

FIG. 1 shows gland packing,

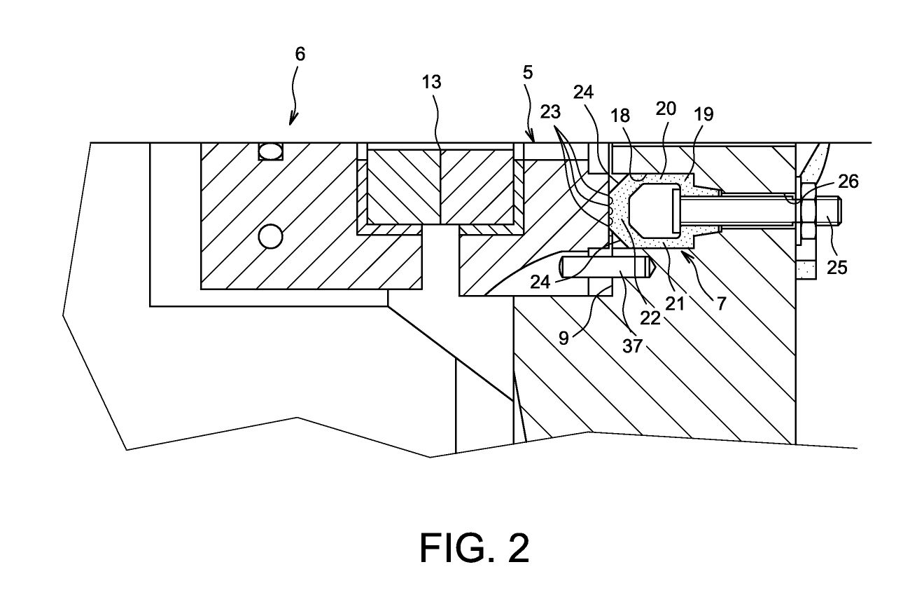

FIG. 2 is an enlargement showing the seal,

FIGS. 3, 4 and 5 show details of the seal,

FIG. 6 is a front view of the seal,

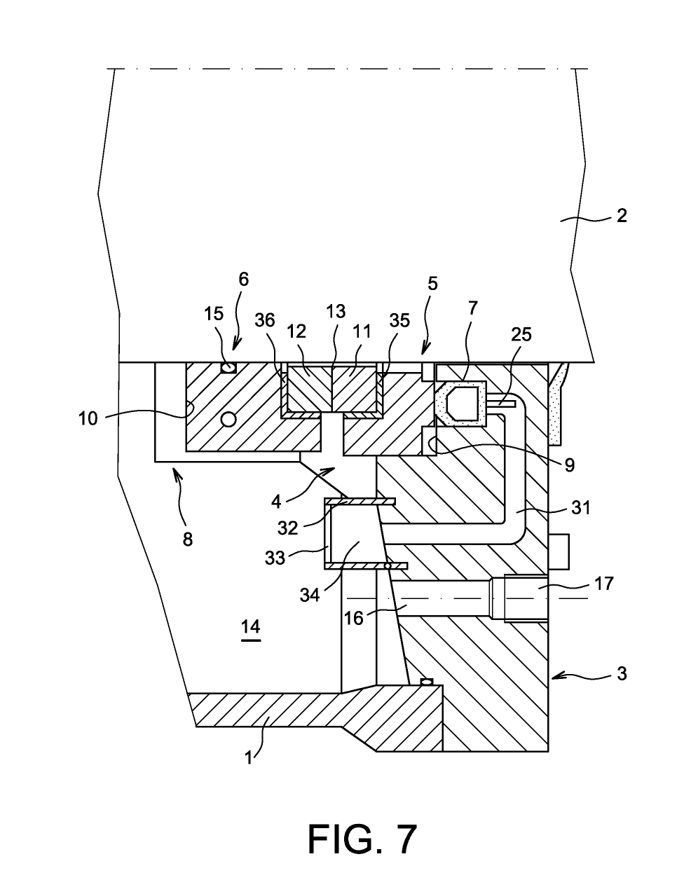

and FIG. 7 is a variant embodiment.

One end of a machine casing (1) is shown partially in FIG. 1. The casing (1) surrounds a rotor shaft (2), the machine being circular around a shaft (X). A housing (3) is assembled and sealed at the end of the casing (1) and surrounds the shaft (2) with a small clearance. Gland packing (4) comprises a fixed block (5), a mobile block (6) and a seal (7) that forms the essential element of the invention. The blocks (5 and 6) are placed in annular cavities in the casing (3) and in a collar (8) of the shaft (2), that have opposite end faces (9 and 10). Blocks are provided with dynamic sealing parts called “washers” (11 and 12 respectively), that are fixed to them and are in mutual contact through slip faces (13). The rotor block (6) bears on the end face (10) of the collar (8), while the seal (7) bears on the end of the stator block (5), pushing it towards the rotor block (6). Packing (4) closes the volume (14) delimited by the casing (1), the shaft (2) and the housing (3); leak tightness is achieved by the seal (7), contact between the slip faces (13) and a static seal (15) arranged between the rotor block (6) and the shaft (2). A drilling (16) that passes through the housing (3) is a degassing orifice closed by an appropriate filter (17). The discussion will now relate to the seal (7) with reference to FIGS. 2, 3, 4 and 5.

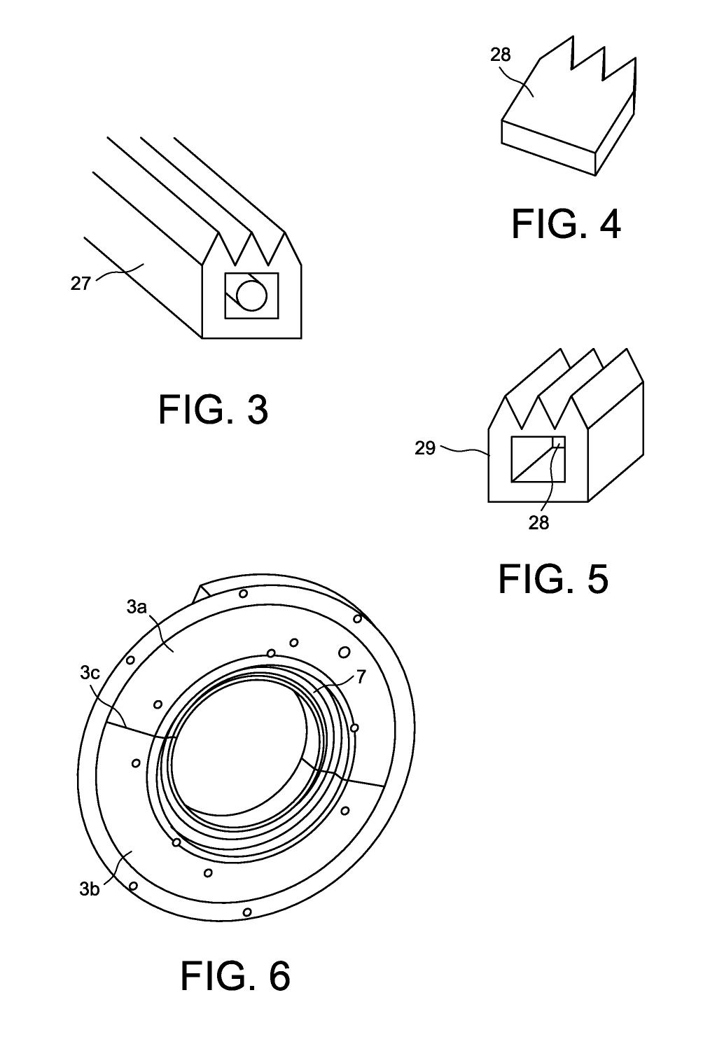

The seal is housed in a groove (18) formed in the end face (9) of the housing (3), while projecting slightly from this groove (18). Its cross-section is prismatic, essentially rectangular in this case so as to bear on the sides of the groove (18) through an end face (19) and two lateral faces (20 and 21), the pressure on the stator block (5) being applied through the fourth face (22) that is provided with grooves and teeth (23) extending along the direction of the circumference of the seal. There may be chamfers (24) between the front face (22) and the lateral faces (20 and 21). The seal (7) has an inflation valve (25) that in this design passes through a conduit (26) formed in the housing (3) and extends as far as the outside of the machine. The seal (7) is made of elastomer, hollow and it may be in a deflated and soft state which makes it very easy to introduce into the groove (18) and an inflated state in which it occupies this groove completely and projects slightly outside it to compress the stator block (5). The seal (7) is composed of a tube (27) with a uniform cross section (referenced in FIG. 3) and two ends designed to close this tube, these ends possibly being flat inserts (28) (FIG. 4) or possibly comprising an extension end piece of the tube (29), with the same cross section as the tube, in addition to this flat insert (28) (FIG. 5). The ends have the same cross section as the tube (27) and therefore may be made perfectly bonded to it by vulcanisation. The length of the tube (27) is such that the ends are adjacent when the seal (7) is placed in the groove (18). Inflation presses them into contact with each other so as to make their junction leak tight. They may be made from a material more flexible than the tube (27) to give a better seal by continuous contact. The teeth (23) extend along the entire length of the seal (7), including at the ends.

FIG. 6 shows that the housing (3) is cuttable and is composed of two halves (3a and 3b) attached to each other through a joint line (3c) like the blocks (5 and 6), as mentioned above. The junction (30) of the ends of the seal (7) is chosen to be at a distance from the joint line (3c) to not deteriorate the seal, which is not difficult because the valve (25) imposes the angular position of the seal (7) in the groove (18).

FIG. 7 shows a slightly different design: the conduit, in this case (31) inside which the valve (25) extends, opens into the volume (14) to be closed by packing (4), such that the fluid contained in this volume itself inflates the seal (7) by entering into the valve (25). Inflation may be either direct, or it may be applied through a pouch of fluid (34) formed around the opening of the conduit (31) and delimited by the housing (3) and a bell (32) comprising a part made from a deformable membrane (33) mounted sealed on the housing (3) around the conduit opening: the fluid contained in the pouch (34) then fills the conduit (31) and the chamber of the seal (7) when it is installed.

Sealing between the blocks (5 and 6) and the washers (11 and 12) is provided by elastic bracelets (35 and 36) compressed together. Pins (37) hold the stator block (5) onto the housing (3) with a small angular clearance. Other pins not shown connect the rotor block (6) to the collar (18). A stiffener (38) is placed in the seal (7) to limit its compression, for example during fluid pressure surges; it is flexible so that it can be curved with the remainder of the seal (7), but has a non-deformable or only slightly deformable section.

1. Gland packing (4) arranged between two opposite elements (3, 8) and around a shaft (2) extending between the two elements, the packing comprising two blocks (5, 6) connected to the elements and in mutual contact through plane slip faces (13), each block being divided into portions extending around the shaft over complementary sectors of the circumference, and also a compression means arranged between one of the elements and one of the blocks and maintaining the slip faces in contact, characterized in that the compression means is an inflatable seal (7) located in a groove (18) of said element (3) and comprising a flexible envelope (27) and an inflation orifice, and the flexible envelope comprises two adjacent closed ends in the groove.

2. Gland packing according to claim 1, characterised in that the envelope (27) is tubular, and the ends have plane faces (28) and are connected to end contours of the envelope.

3. Gland packing according to claim 2, characterised in that the envelope section is advantageously prismatic when it is inflated, and the ends have an identical prismatic shape.

4. Gland packing according to claim 3, characterised in that the prismatic shape and section are essentially rectangular.

5. Gland packing according to claim 3, characterised in that the envelope has one face bearing on the block on which parallel teeth (23) are formed extending from one end to the other.

6. Gland packing according to claim 1, characterised in that the orifice comprises a filling valve (25).

7. Gland packing according to claim 6, characterised in that the valve opens into a conduit (31) opening into a fluid volume (14) contained by the packing.

8. Gland packing according to claim 7, characterised in that the fluid volume is divided by a flexible membrane (33) into a main volume opening onto slip faces and an ancillary volume opening onto the conduit.

9. Gland packing according to claim 1, characterised in that the seal contains a flexible stiffener (38).

10. Gland packing according to claim 6, characterised in that the valve opens into a conduit (26) leading to an outer face of the element.
